(19) United States
(12) Patent Application Publication
(10) Pub. No.: US 2026/0359907 A1
(43) Pub. Date: Nov. 12, 2026

(54) SYSTEM FOR AUTOMATED CLIENT AND ATTORNEY MATCHING

(71) Applicant: Deter Guardian LLC, West Hartford, CT (US)

(72) Inventor: Brian Namnoum, West Hartford, CT (US)

(73) Assignee: Deter Guardian LLC, West Hartford, CT (US)

(21) Appl. No.: 19/645,976

(22) Filed: Apr. 13, 2026

Related U.S. Application Data
(60) Provisional application No. 63/804,243, filed on May 12, 2025.

(51) Int. Cl. G06Q 50/18

(52) U.S. Cl. CPC G06Q 50/18

(57) ABSTRACT

A system and method for automated client and attorney matching, including a platform with an artificial intelligence (AI) engine operable to receive client input, analyze the client input, compare the client input to a database of attorney profiles, recommend a client-attorney match, initiate an audio or visual call to a client, verify the client information, initiate a call to an attorney, merge the call between the client and the attorney, and leave the call such that the client and the attorney remain on the call. The system is operable to determine a compatible client and attorney match, based on automated analysis of a client profile and an attorney profile, which include client and attorney information.

### CROSS REFERENCES TO RELATED APPLICATIONS

This application is related to and claims priority from the following U.S. patent applications. This application claims priority to and the benefit of U.S. Provisional Application No. 63/804,243, filed May 12, 2025, which is incorporated herein by reference in its entirety.

### BACKGROUND OF THE INVENTION

### 1. Field of the Invention The present invention relates to a system for legal marketing, and more specifically to an automated system for client and attorney matching.

### 2. Description of the Prior Art

It is generally known in the prior art to provide lead generation systems and call merging technology.

Prior art patent documents include the following:
U.S. Pat. No. 8,600,025 for System and method for merging voice calls based on topics by inventors Walsh, et al., filed Dec. 22, 2009, and issued Dec. 3, 2013, is directed to a system and method for merging a first voice call and a second voice call. A first topic discussed during the first voice call is compared to a second topic discussed during the second voice call. If the first topic matches the second topic, the first voice call may be merged with the second voice call. A semantic analysis may be performed on the first topic and the second topic to determine if the first topic and the second topic match one another. Filter criteria may be defined by participants of the first voice call and the second voice call that identify criteria that may preclude merger of the first voice call and the second voice call.
U.S. Pat. No. 9,877,176 for Methods and systems of managing accident communications over a network by inventor Gabel, filed Dec. 18, 2013, and issued Jan. 23, 2018, is directed to systems and methods configured to detect the occurrence of accidents, and to collect, process, and distribute accident related data. The accident related information may include location information, accident image information, and/or other information. Optionally, upon detection of an accident, emergency contacts of a user involved in the accident may be automatically notified of the accident. Service providers may be contacted over a network to provide accident-related services.
U.S. Pat. No. 7,120,668 for Systems and methods for matching participants to a conversation by inventors Manber, et al., filed Oct. 14, 2003, and issued Oct. 10, 2006, is directed to systems and methods for connecting two or more individuals to an Internet conversation based on their mutual interests, the current content they may be viewing and what they want to talk about at that time. The techniques allow an individual who starts a conversation to maintain full control over who is able to join that conversation as well as how many are able to join at any one time. A user who desires to start or join a conversation about a particular topic or story selects an indicator, such as an icon, associated with the specific topic or story. The user is presented with an option to start or join a conversation. If the user opts to start a conversation, the user is presented with a comment page, and the user enters a comment, or comments, that preferably is intended to spark an interest in other users. The comment is then presented to other users. Those users who may desire to join in a conversation with the conversation starter respond with their own comment, which is then sent to the conversation starter. The conversation starter reviews the comment, and if the comment is subjectively acceptable, the conversation starter brings the responding user into a conversation. The responding user and conversation starter are then connected in a messaging session, such as an instant messaging session. Multiple users may be connected in a single messaging session by the conversation starter in this manner.
U.S. Pat. No. 10,742,817 for Conference call notification and setup configuration by inventors white et al., filed Sep. 5, 2018, and issued Aug. 11, 2020, is directed to receiving a conference request from a moderator device, retrieving user profiles, included in the conference request, stored in a database, transmitting a conference access code to the user devices associated with the user profiles, retrieving and applying a moderator conference call agenda to a conference call at a conference call maturity time, and enacting one or more restrictions during the conference call based on the moderator conference call agenda.
U.S. Pat. No. 11,501,262 for Dynamic and automated management of meetings based on contextual information by inventors Shetty, et al., filed Feb. 6, 2019, and issued Nov. 15, 2022, is directed to identifying topics to apply to a meeting having a defined time window, creating meeting time intervals corresponding to the topics, transmitting meeting invites to user accounts identified as potential meeting attendees, identifying when the user accounts were active in the meeting, and determining the user accounts fulfilled a topic fulfillment obligation of one or more of the topics based on a user account presence during one or more of the meeting intervals.
US Patent Publication No. 2017/0316383 for Meeting setup system and method by inventors Naganathan, et al., filed Apr. 28, 2016, and published Nov. 2, 2017, is directed to a meeting request received that specifies a first participant account and a proposed topic for a meeting. A database is traversed to determine one or more second participant accounts for the meeting that are linked to the proposed topic. The meeting is scheduled with the first participant account and the one or more second participant accounts. The database contains data for a plurality of accounts (including the first participant account and the one or more second participant account) associated with entities, a plurality of events involving the entities, a plurality of prior topics derived from the events, and a plurality of links between the accounts, events and prior topics.
US Patent Publication No. 2018/0101760 for Selecting meeting participants for electronic meetings using artificial intelligence by inventors Nelson, et al., filed Oct. 11, 2016, and published Apr. 12, 2018, is directed to artificial intelligence introduced into an electronic meeting context to perform various tasks before, during, and/or after electronic meetings. The tasks may include a wide variety of tasks, such as agenda creation, participant selection, real-time meeting management, meeting content supplementation, and post-meeting processing. The artificial intelligence may analyze a wide variety of data such as data pertaining to other electronic meetings, data pertaining to organizations and users, and other general information pertaining to any topic. Capability is also provided to create, manage, and enforce meeting rules templates that specify requirements and constraints for various aspects of electronic meetings.
U.S. Pat. No. 10,373,198 for System and method of generating existing customer leads by inventors Cook, et al., filed Aug. 5, 2015, and issued Aug. 6, 2019, is directed to an existing customer lead generation system comprising a vendor customer information database, a vendor criteria database, a web server, a matching engine, and a transmission component. The vendor customer information database identifies vendor's existing customers. The vendor criteria database determines which leads each vendor wants to receive. Separate criteria may be specified for consumers that are existing customers and consumers that are not existing customers. The web server receives characteristics of a consumer and a product or service. The matching engine compares the consumer characteristics with the vendor customer information database to identify vendors for which the consumer is an existing customer. The matching engine applies existing customer criteria to match the consumer with existing vendors. The matching engine applies non-existing customer criteria to match the consumer with other vendors. The transmission component transmits a lead identifying the consumer to the matched vendors.
US Patent Publication No. 2023/0274319 for System and method for text-based lead generation by inventors Doumar, et al., filed Feb. 22, 2023, and published Aug. 31, 2023, is directed to a system and method for text message-based lead generation. A computing device generates and transmits a passive call-to-action comprising a uniform resource locator configured to prepopulate a ready-to-send text message comprising a payload. Upon receipt of a text message substantially corresponding to the payload, device-specific data is used to match the mobile device to a specific end user. The end user is added to a database if not present, and a consumer profile for the end user is obtained and used to generate a response to be sent to the mobile device.
US Patent Publication No. 2022/0270114 for Method and system for automatic lead generation based on public documents by inventors Kaur, et al., filed Feb. 23, 2021, and published Aug. 25, 2022, is directed to a method for automatically generating leads for solicitation of prospective clients. The method includes: accessing identification information that relates to an entity that has registered with a government agency via a web site associated with the agency; automatically downloading a document that the entity has filed with the agency from the web site; extracting additional information from the downloaded document; determining an identity of a target group for solicitation of the entity as a prospective client based on the accessed information and the extracted information; and routing a relevant portion of the information to the target group.

### SUMMARY OF THE INVENTION

The present invention relates to legal marketing, and more specifically to an automated system for client and attorney matching.

It is an object of this invention to provide an automated system for matching clients with legal needs to compatible attorneys.

In one embodiment, the present invention includes a method for automated client and attorney matching, including, providing, via a graphical user interface (GUI), a questionnaire, receiving, by a computer processor including a memory, an input to the questionnaire, analyzing, by at least one artificial intelligence (AI) engine, the input to determine a jurisdiction and/or a case type, referencing, by the AI engine, at least one database, wherein the at least one database includes a plurality of attorney profiles, selecting, by the AI engine, at least one attorney profile that matches the jurisdiction and/or the case type of the input, automatically initiating, by the AI engine, a message to a user, wherein the AI engine is operable to send and receive messages in real time, receiving, by the AI engine, at least one response message, referencing, by the AI engine, at least one calendar database, and scheduling, by the AI engine, a meeting between an attorney of the at least one attorney profile and the user.

In another embodiment, the present invention includes a system for automated client and attorney matching, including, a server platform with a processor including a memory and the server platform includes at least one artificial intelligence (AI) engine, wherein the server platform is operable to provide a questionnaire via a graphical user interface (GUI), wherein the server platform is operable to receive an input to the questionnaire, wherein the AI engine is operable to analyze the input to determine a jurisdiction and/or a case type, wherein the AI engine is operable to reference at least one database, wherein the at least one database includes a plurality of attorney profiles, wherein the AI engine is operable to select at least one attorney profile that matches the jurisdiction and/or the case type of the input, wherein the AI engine is operable to automatically initiate a message to a user, wherein the AI engine is operable to send and receive messages in real time, wherein the AI engine is operable to receive at least one response message, and wherein the AI engine is operable to schedule a meeting between an attorney of the at least one attorney profile and the user.

In yet another embodiment, the present invention includes a method for automated client and attorney matching, including, providing, via a graphical user interface (GUI), a questionnaire, wherein the questionnaire includes at least one question, wherein the at least one question relates to a legal case type, a legal charge, a jurisdiction, a date of a charge, a date of a scheduled court appearance, a legal fee range, and/or an availability schedule, receiving, by a computer processor including a memory, an input to the questionnaire, analyzing, by at least one artificial intelligence (AI) engine, the input to determine a jurisdiction and/or a case type, referencing, by the AI engine, at least one database, wherein the at least one database includes a plurality of attorney profiles, selecting, by the AI engine, at least one attorney profile that matches the jurisdiction and/or the case type of the input, automatically initiating, by the AI engine, a message to a user, wherein the AI engine is operable to send and receive messages in real time, receiving, by the AI engine, at least one response message, referencing, by the AI engine, at least one calendar database, and scheduling, by the AI engine, a meeting between an attorney of the at least one attorney profile and the user.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1A illustrates a schematic diagram of the system of the present invention, according to one embodiment.

FIG. 1B illustrates a schematic diagram of the system of the present invention, according to one embodiment.

FIG. 1C illustrates a schematic diagram of the system of the present invention, according to one embodiment.

FIG. 1D illustrates a schematic diagram of the system of the present invention, according to one embodiment.

FIG. 2 illustrates a graphical user interface (GUI) of the platform of the present invention according to one embodiment.

FIG. 3 is a block diagram of the steps performed by a platform for providing attorney client matching recommendations according to one embodiment of the present invention.

FIG. 4 is a schematic diagram of a system of the present invention.

### DETAILED DESCRIPTION

The present invention is generally directed to a system for legal marketing, and more specifically to an automated system for client and attorney matching.

In one embodiment, the present invention includes a method for automated client and attorney matching, including, providing, via a graphical user interface (GUI), a questionnaire, receiving, by a computer processor including a memory, an input to the questionnaire, analyzing, by at least one artificial intelligence (AI) engine, the input to determine a jurisdiction and/or a case type, referencing, by the AI engine, at least one database, wherein the at least one database includes a plurality of attorney profiles, selecting, by the AI engine, at least one attorney profile that matches the jurisdiction and/or the case type of the input, automatically initiating, by the AI engine, a message to a user, wherein the AI engine is operable to send and receive messages in real time, receiving, by the AI engine, at least one response message, referencing, by the AI engine, at least one calendar database, scheduling, by the AI engine, a meeting between an attorney of the at least one attorney profile and the user, wherein the plurality of attorney profiles include attorney information including, a jurisdiction of practice, at least one case type, and an availability schedule, wherein the questionnaire includes at least one question, wherein the at least one question relates to a legal case type, a legal charge, a jurisdiction, a date of a charge, a date of a scheduled court appearance, a legal fee range, and/or an availability schedule, wherein the message and the at least one response message are text messages, further comprising automatically generating a financing plan based on the case type and the at least one attorney profile, wherein the at least one attorney profile includes a fee schedule, further comprising automatically generating an alert at the time of the scheduled meeting between an attorney of the at least one attorney profile and the user, further comprising verifying, by the AI engine, the jurisdiction and case type based on public records, wherein the public records include public arrest records and/or public court records, further comprising verifying an identify of a user, and further comprising verifying an identify of a user by a series of text message prompts.

In another embodiment, the present invention includes a system for automated client and attorney matching, including, a server platform with a processor including a memory and the server platform includes at least one artificial intelligence (AI) engine, wherein the server platform is operable to provide a questionnaire via a graphical user interface (GUI), wherein the server platform is operable to receive an input to the questionnaire, wherein the AI engine is operable to analyze the input to determine a jurisdiction and/or a case type, wherein the AI engine is operable to reference at least one database, wherein the at least one database includes a plurality of attorney profiles, wherein the AI engine is operable to select at least one attorney profile that matches the jurisdiction and/or the case type of the input, wherein the AI engine is operable to automatically initiate a message to a user, wherein the AI engine is operable to send and receive messages in real time, wherein the AI engine is operable to receive at least one response message, wherein the AI engine is operable to schedule a meeting between an attorney of the at least one attorney profile and the user, wherein the plurality of attorney profiles include attorney information including, a jurisdiction of practice, at least one case type, and an availability schedule, wherein the questionnaire includes at least one question, wherein the at least one question relates to a legal case type, a legal charge, a jurisdiction, a date of a charge, a date of a scheduled court appearance, a legal fee range, and/or an availability schedule, wherein the message and the at least one response message are text messages, wherein the AI engine is operable to automatically generate a financing plan based on the case type and the at least one attorney profile, wherein the at least one attorney profile includes a fee schedule, and wherein the AI engine is operable to automatically generate an alert at the time of the scheduled meeting between an attorney of the at least one attorney profile and the user.

In yet another embodiment, the present invention includes a method for automated client and attorney matching, including, providing, via a graphical user interface (GUI), a questionnaire, wherein the questionnaire includes at least one question, wherein the at least one question relates to a legal case type, a legal charge, a jurisdiction, a date of a charge, a date of a scheduled court appearance, a legal fee range, and/or an availability schedule, receiving, by a computer processor including a memory, an input to the questionnaire, analyzing, by at least one artificial intelligence (AI) engine, the input to determine a jurisdiction and/or a case type, referencing, by the AI engine, at least one database, wherein the at least one database includes a plurality of attorney profiles, selecting, by the AI engine, at least one attorney profile that matches the jurisdiction and/or the case type of the input, automatically initiating, by the AI engine, a message to a user, wherein the AI engine is operable to send and receive messages in real time, receiving, by the AI engine, at least one response message, referencing, by the AI engine, at least one calendar database, scheduling, by the AI engine, a meeting between an attorney of the at least one attorney profile and the user, wherein the plurality of attorney profiles include attorney information including, a jurisdiction of practice, at least one case type, and an availability schedule, wherein the message and the at least one response message are text messages, further comprising automatically generating a financing plan based on the case type and the at least one attorney profile, wherein the at least one attorney profile includes a fee schedule, and further comprising automatically generating an alert at the time of the scheduled meeting between an attorney of the at least one attorney profile and the user.

None of the prior art discloses an automated system for client and attorney matching, wherein an artificial intelligence (AI) engine is operable to analyze and determine similarities between client and attorney information in order to match a client to a compatible attorney.

If an individual is involved in a court case or is charged with a crime or misdemeanor, it is generally recommended that the individual contact an attorney for legal advice and legal representation. However, that is not a simple task as there are more than 1.3 million attorneys in the United States alone. When a client is in legal trouble or is just in need of legal counsel and guidance, there are simply too many choices of attorneys for an individual to choose from.

Traditional methods of finding an attorney include personal referrals, online searches, legal directories, and legal referral services. However, these traditional methods do not always lead to the most compatible attorney-client matches, which can lead to miscommunication, hostility, an aggravated attorney-client relationship, and/or ineffective representation. Thus, there is a need for a more compatible attorney-client matching system to match attorneys to a client's specific needs.

Additionally, once a client finds a prospective attorney, the client may have to undergo a consultation, which consumes the client's time and potentially the client's money, just to find out the attorney is not compatible with the client or the client's issue, or the attorney cannot represent the client due to a conflict. Thus, the client may have to endure various consultations with various attorneys in order to find the attorney best suited for the client's needs, which can consume a client's time and money. Thus, there is a need for a more streamlined and automated attorney-client matching system.

The present invention provides a system for legal marketing, including automated client and attorney matching.

Referring now to the drawings in general, the illustrations are for the purpose of describing one or more preferred embodiments of the invention and are not intended to limit the invention thereto.

### System Structure

In one embodiment, the present invention provides a system for legal marketing services, including automated attorney and client matching services.

In one embodiment, the system includes a server platform. In one embodiment, the server platform includes at least one server computer and at least one user device. The at least one server platform is network-based or cloud-based. The at least one server platform includes at least one processor and at least one memory. The at least one user device includes, but is not limited to, a desktop computer, a laptop computer, a smartphone, and/or a tablet. The at least one user device is operable to display a graphical user interface (GUI) for the server platform through a native web page, a downloaded software, and/or a mobile application. The GUI is preferably optimized for display in mobile and/or web formats.

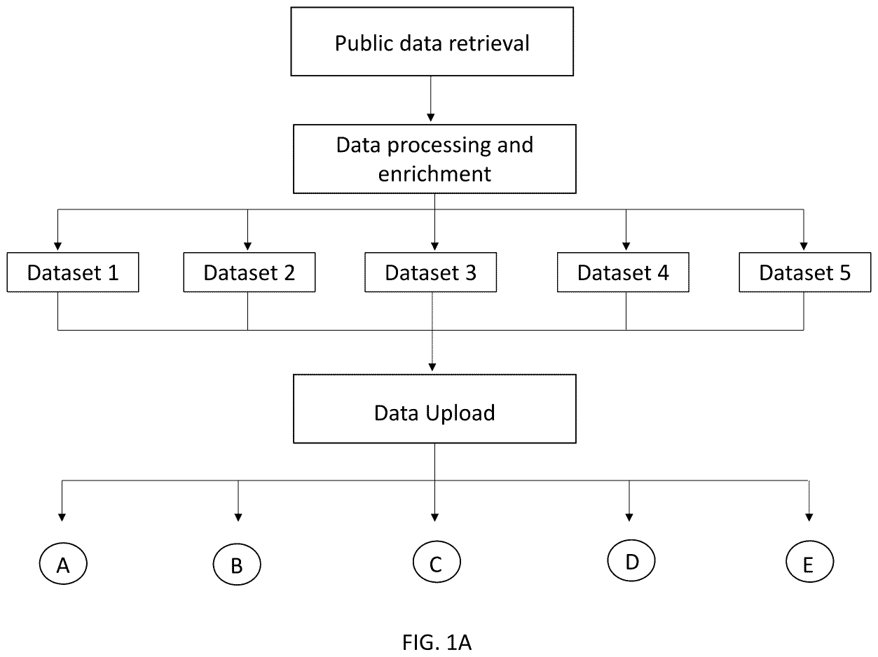

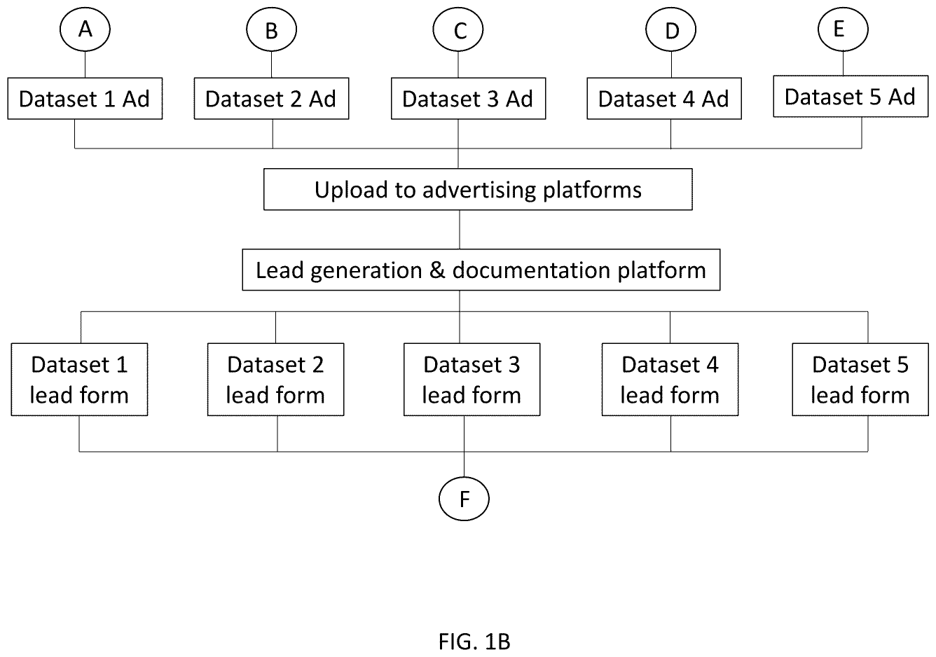

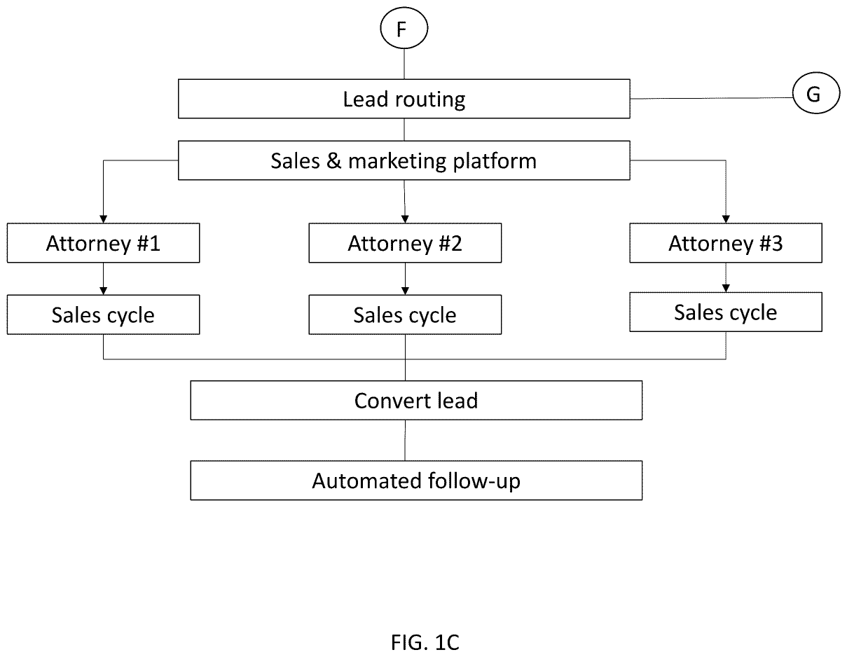

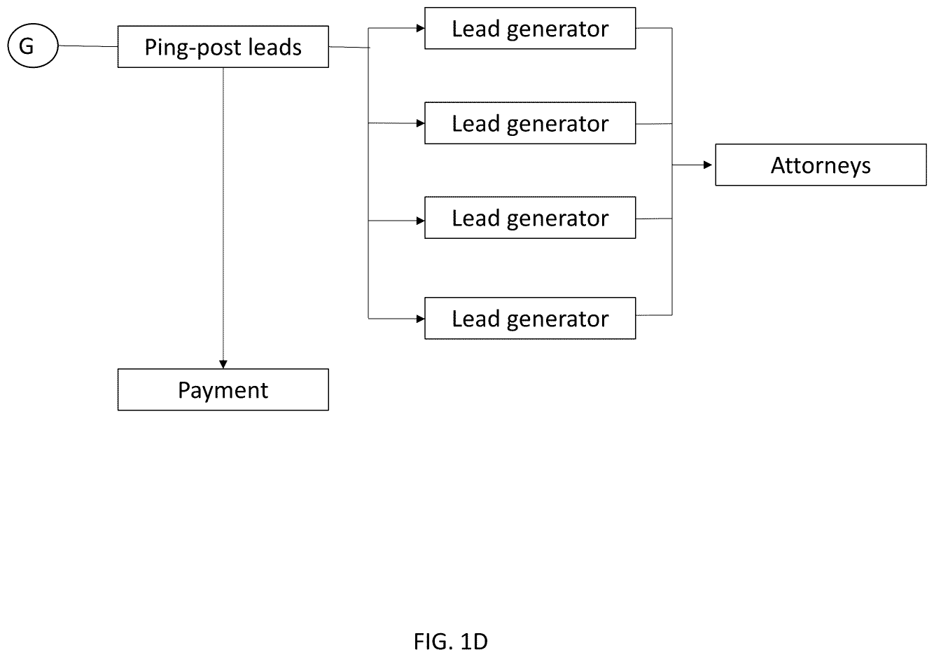

FIGS. 1A-1D illustrate a schematic diagram of the system of the present invention, according to one embodiment. In one embodiment, the system is operable to retrieve and acquire data from at least one public record database, wherein the data includes any publicly available arrest data. In one embodiment, the system is operable to use a web crawler to identify and retrieve the data. In one embodiment, the system is operable to perform data scraping of public arrest record databases. In one embodiment, the public arrest record database is a county public arrest record database.

The system is then operable to process the data, wherein the system is operable to process the data based on the format of the data. In one embodiment, the system is operable to enrich the data by adding contact information of the individual charged to the data, wherein the contact information includes at least a phone number and/or email address. In one embodiment, the system is operable to categorize the data, wherein the system is operable to categorize the data based on the charge type, wherein each category of data is identified as a separate dataset. For example, the system is operable to retrieve public arrest data from a specific county and then categorize the arrest data based on the charge type, such as driving under the influence (DUI), assault, drug charges, warrants, and/or criminal defense.

The system is further operable to upload the categorized datasets to at least one database, wherein the at least one database is an advertising platform database, wherein the categorized datasets are converted into categorized dataset advertisements. In one embodiment, the categorized dataset advertisements are based on the charge type. The categorized dataset advertisements are then operable to be distributed and/or uploaded to at least one additional database, such as an additional advertising database or a social media platform database.

In one embodiment, the system is further operable to upload the categorized datasets and/or the categorized dataset advertisements to at least one lead distribution platform for lead routing. Based on the categorized datasets and/or the categorized dataset advertisements, the system is operable to generate a form for each categorized dataset and/or the categorized dataset advertisement for lead routing.

In one embodiment, the system is operable to perform lead routing. For example, if a charged individual (a lead) requested help in a specific county, the system is operable to route the lead request to an attorney who serves clients in the specific county.

If a lead request cannot be sent to any attorneys, such as based on the case type or location, the system is operable to ping-post the lead request to other lead generators/buyers. Thus, the system is operable to transmit partial data of a lead request to a plurality of lead generators/buyers, wherein the system is operable to receive a response, including an acceptance or a rejection of the lead request or a bid for the lead request. Upon acceptance of the lead request, the system is operable to transmit the full lead request data.

### Profiles

The server platform is operable to receive a request from at least one user device (e.g., a mobile phone, a computer, a tablet, etc.) to create an account and/or a user profile corresponding to one or more users. The server platform includes a plurality of accounts that are created upon registration with the server platform, with each account being linked to at least one user profile. Each of the at least one user profile includes account information identifying aspects of the user, user preferences, historical data for the user, and/or other data. Account information includes, but is not limited to, a name (e.g., first name, middle name, last name, nickname, username), a date of birth, a gender, an age, a race, an ethnicity, a physical address, a personal identification number (e.g., social security number (SSN), individual taxpayer identification number (ITIN)), at least one financial account (e.g., bank account number, credit card number, debit card number, digital wallet address, etc.), a job title, at least one email address, at least one phone number, a level of education, one or more additional authorized users with access to the account (e.g., a spouse, a child, etc.), and/or other user preferences. In one embodiment, the at least one user profile includes at least one designated means of contact for recovering account information (e.g., at least one email address, at least one phone number, at least one linked social media account, etc.).

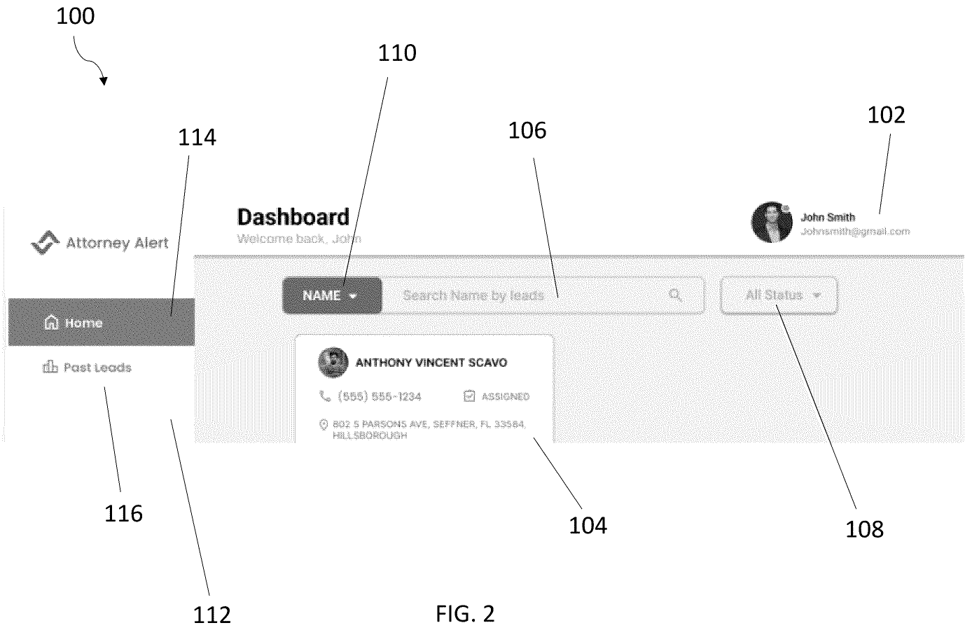

In one embodiment, the account and/or user profile is a client account and/or client user profile. In one embodiment, the account and/or user profile is an attorney account and/or attorney user profile. FIG. 2 illustrates a GUI of the platform 100, including an attorney user profile 102, a client lead profile 104, a search field for searching client leads 106, a status filter 108, a search filter 110, and a menu 112 including navigation to a homepage 114 and a past leads 116 page.

In one embodiment, an attorney account and/or user profile includes additional account information including the attorney's area of practice, state(s) of admission to practice law, the attorney's bar number(s), hourly rate, retainer fee, schedule, availability, jurisdiction of practice, including federal and/or state court, physical office location, contact information, success rate for specific types of cases, any expertise areas of law, and/or any other information.

In one embodiment, the attorney account is operable to integrate and sync with a calendar application on the same device, including, but not limited to, GOOGLE CALENDAR, MICROSOFT OUTLOOK CALENDAR, APPLE CALENDAR, and/or any other calendar or scheduling application or software. In one embodiment, the platform is operable to automatically update the attorney account schedule and/or availability information based on the integrated calendar application. In one embodiment, the platform is operable to integrate and sync a user account with a calendar application, including, but not limited to, GOOGLE CALENDAR, MICROSOFT OUTLOOK CALENDAR, APPLE CALENDAR, and/or any other calendar or scheduling application or software. In one embodiment, the platform is operable to automatically update the user account schedule and/or availability information based on the integrated calendar application. In another embodiment, the platform is operable to automatically update the user account schedule and/or calendar based on scheduled court dates. In another embodiment, the platform is operable to automatically generate an alert reminder for a scheduled court date on a user's calendar or on an attorney's calendar.

In one embodiment, upon registration of a user profile and/or at a later time, the server platform receives answers to one or more challenge questions for a user profile. In one embodiment, the one or more challenge questions are selected from a pre-established list (e.g., What was your first pet?, What model was your first car?, etc.). In one embodiment, the server platform receives an input of a custom question and an answer for a user profile.

In one embodiment, the server platform prompts the user device to register one or more items of biometric information to associate with the user profile. In one embodiment, the biometric information includes one or more fingerprints, one or more retinal scans, one or more facial scans, and/or one or more voice samples (e.g., for voice pattern analysis). In one embodiment, upon registration of a user profile, the server platform prompts the user device to perform one or more typing tests in order to analyze a user's keystroke pattern. In one embodiment, in order to log-in to the user profile, the server platform prompts a user to perform a typing test and compares the results to the user's keystroke pattern registered in association with the user profile. In another embodiment, the keystroke pattern is recognized as the username and/or password is entered to log into an account. Examples of keystroke recognition systems able to be utilized with the present invention include, but are not limited to, that described in U.S. Pat. No. 6,954,862. In one embodiment, at least one artificial intelligence module is used to detect and form a keystroke signature for each user and/or to recognize a user inputted keystroke pattern as matching the keystroke signature for a particular user profile.

In one embodiment, the platform is operable to request additional client information, wherein the platform creates a questionnaire with the additional client information to be completed by the client. In one embodiment, the additional client information includes the facts of the client's case, the applicable area of law, the legal issue of the case, the date of the issue, the date of first court appearance, the location of the issue, the jurisdiction of the issue, including the court of the issue, the client's budget, contact information, and/or any other information.

The server platform is able to receive a username and a password from a user device in order to login to a user profile on the user device. In one embodiment, the server platform is able to receive a selection of “Forgot My Password” and receives a selection of one or more means of communication (e.g., at least one email address, at least one phone number). In one embodiment, the server platform automatically transmits a message to the one or more means of communication prompting to enter a new password. In another embodiment, the server platform automatically transmits a message to the one or more means of communication including the existing username and password information to allow the user to sign in.

In one embodiment, the server platform receives biometric information in order to login the user into the user profile. Biometric information includes, but is not limited to, retinal data, a facial image scan, one or more fingerprints, and/or voice pattern recognition. In one embodiment, biometric information includes a typing test to recognize a keystroke signature previously associated with the user profile.

In one embodiment, after successfully entering a username and password, the user device generates a challenge question GUI. In one embodiment, the server platform prompts for answers to one or more challenge questions associated with the at least one user profile. In another embodiment, the GUI on the user device includes a drop-down menu for a user profile to select one or more challenge questions and subsequently enter an answer matching a question and answer associated with the user profile. In one embodiment, the drop-down menu only includes questions previously associated with the user profile. In another embodiment, the drop-down menu includes questions having answers associated with the user profile as well as questions without answers associated with the user profile, forcing the user to know which questions have previously been addressed. In one embodiment, rather than being used as a subsequent step to entering a username and password, the challenge question GUI is required in order to authorize the server platform to send an account retrieval message to a designated account recovery communication means and/or to otherwise recover a username and password.

In one embodiment, the system includes an option for a user device to sign in to a user profile via scanning at least one unique visual code. Examples of unique visual codes include bar codes, a quick response (QR) code, and/or any other form of visual code. After the user device scans the at least one unique visual code (e.g., via at least one camera and/or LiDAR sensor on the user device), the scan data is transmitted to the server platform. The server platform verifies the validity of the at least one unique visual code and/or matches the at least one unique visual code with the user profile. If the at least one unique visual code is successfully matched, then the user profile is logged in on the scanning user device.

In one embodiment, the system includes an option to log-in via at least one other device. In this system, when an attempt is made to log in on a first user device, the first user device automatically generates and displays a unique log-in code and a prompt to visit a log-in code page on a user device that is already signed in to the user profile. Through the signed in user device (e.g., a mobile phone, a smart television, a computer, tablet, a smart watch, etc.), the server platform receives an input of the unique log-in code. Subsequently, the server platform automatically signs in the first user device to the user profile.

In one embodiment, in order to verify that the users logging in are legitimate users and not bots, the server platform generates at least one Completely Automated Public Turing test to tell Computers and Humans Apart (CAPTCHA). Upon the server platform receiving a selection that indicates a positive result for the at least one CAPTCHA, the user profile is successfully logged in.

In one embodiment, in order to login to a user profile, the user device transmits a login message to the server platform including location metadata. In one embodiment, the location metadata is generated by a Global Positioning System (GPS) chip found in the user device. In one embodiment, the server platform authenticates or rejects the login attempt based on the associated location metadata. By way of example and not limitation, if a user from one or more restricted countries (e.g., Argentina is restricted) attempts to login to a user profile, then the server platform automatically rejects the login attempt. In this embodiment, the server platform maintains a location blacklist, designating one or more locations from which login attempts will be rejected. However, in another embodiment, the server platform includes a location whitelist, designating a limited number of locations from which login attempts are able to be authenticated. This is particularly useful for security purposes and ensuring, by way of example and not limitation, that only login attempts made from a user's home are able to be accepted. In one embodiment, the whitelists and/or blacklists are global whitelists and/or blacklists that apply to all user profiles on the server platform. In another embodiment, the whitelists and/or blacklists are specific to each user profile, meaning locations are able to be restricted or allowed with respect to specific user profiles, but not with regard to other user profiles.

One of ordinary skill in the art will understand that one or more of the above-mentioned authentication methods are able to be used in order to log in a user device into a user profile. In one embodiment, the system utilizes multifactor authentication, transmitting an authentication message via one or more communication means (e.g., phone number, email address, one or more linked social media accounts, etc.) including a link to authenticate a login attempt and/or a code to enter in order to complete the login attempt.

In one embodiment, the platform is operable to generate a database of all attorney accounts/user profiles. In one embodiment, the platform is operable to generate a database of all client accounts/user profiles.

The platform is operable to utilize a plurality of learning techniques including, but not limited to, machine learning (ML), artificial intelligence (AI), deep learning (DL), neural networks (NNs), artificial neural networks (ANNs), support vector machines (SVMs), Markov decision process (MDP), and/or natural language processing (NLP). The platform is operable to use any of the aforementioned learning techniques alone or in combination.

Further, the platform is operable to utilize predictive analytics techniques including, but not limited to, machine learning (ML), artificial intelligence (AI), neural networks (NNs) (e.g., long short term memory (LSTM) neural networks), deep learning, historical data, and/or data mining to make future predictions and/or models. The platform is preferably operable to recommend and/or perform actions based on historical data, external data sources, ML, AI, NNs, and/or other learning techniques. The platform is operable to utilize predictive modeling and/or optimization algorithms including, but not limited to, heuristic algorithms, particle swarm optimization, genetic algorithms, technical analysis descriptors, combinatorial algorithms, quantum optimization algorithms, iterative methods, deep learning techniques, and/or feature selection techniques.

In one embodiment, the platform is operable to automatically generate an attorney account and/or profile. In one embodiment, the platform is operable to automatically generate a client account and/or profile.

In one embodiment, the platform is operable to automatically generate an attorney profile based on any publicly available information on an attorney. In one embodiment, web crawlers and/or artificial intelligence (AI) tools are operable to gather and collect data from a plurality of different public sources and/or entities on the internet in order to generate an attorney profile.

### Client—Attorney Matching

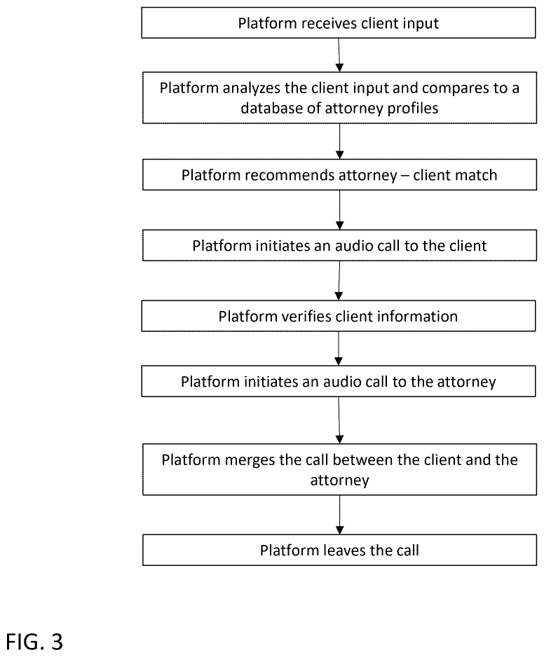

FIG. 3 is a block diagram of the steps performed by a platform of the present invention for providing attorney-client matching recommendations according to one embodiment of the present invention. In one embodiment, the platform receives client input, wherein the platform analyzes the client input and compares the client input to a database of attorney profiles. In one embodiment, the platform includes an AI engine. In one embodiment, the AI engine is operable to summarize the client input and provide the summary to an attorney account. In one embodiment, the AI engine is operable to analyze similarities between a client account and an attorney account in order to determine and match a client to an attorney. In one embodiment, the AI engine is operable to match a client and an attorney based on the attorney's strengths, as described in the attorney's account with the client's needs, as described in the client's account. In one embodiment, the AI engine is operable to match a client and an attorney based on an attorney's availability, expertise, and/or previous success rate on similar legal cases, all of which is included in an attorney account. In one embodiment, the AI engine is operable to match a client and an attorney based on an attorney's jurisdiction of practice. In one embodiment, the AI engine is operable to match a client and an attorney based on the legal charge type or category.

In one embodiment, the platform utilizes natural language processing to analyze client accounts to determine the urgency, sincerity, and/or viability of a client's legal case. In one embodiment, the platform is operable to determine the urgency of a client's legal case based on public records, including public violations and/or court schedules. In one embodiment, the platform is operable to determine the sincerity of a client's legal case based on public violation and/or court records.

In one embodiment, the platform is operable to verify the client information for accuracy and truthfulness. In one embodiment, the AI engine is operable to verify the information within a client account based on publicly available information. In one embodiment, web crawlers and/or artificial intelligence (AI) tools are operable to gather and collect data from a plurality of different public sources and/or entities on the internet. In one embodiment, the AI engine is operable to verify the client's legal case based on public violation and/or court records.

In one embodiment, the AI engine is operable to verify the information within an attorney account, based on publicly available information. In one embodiment, web crawlers and/or artificial intelligence (AI) tools are operable to gather and collect data from a plurality of different public sources and/or entities on the internet. In one embodiment, the AI engine is operable to verify the attorney's license information based on public state bar records.

In one embodiment, the AI engine is operable to determine the viability of a client's legal case by analyzing the facts input by the client, utilizing natural language processing, and comparing the facts to the applicable law and/or similar past public legal cases. In one embodiment, the AI engine is operable to predict the outcome of a client's legal case by analyzing the facts input by the client, utilizing natural language processing, and comparing the facts to the applicable law and/or similar past public legal cases. In one embodiment, the AI engine is operable to receive an input from a user, wherein the user is an attorney, wherein the user inputs questions related to a client's legal case and the AI engine is operable to provide recommendations and/or suggestions for handling the client's legal case.

In one embodiment, the AI engine of the server platform is operable to initiate a message to a user, wherein the message includes short message services (SMS), multimedia messaging services (MMS), or rich communication services (RCS). In one embodiment, the AI engine is operable to verify the identity of the user by a series of text message prompts, wherein the AI engine is operable to receive text message responses from the user.

In one embodiment, the AI engine is operable to engage in text message conversations with a user. In one embodiment, once the AI engine has verified the identity of the user, the AI engine is operable to engage in text message conversations with a user to identify and/or verify a jurisdiction/geographic area of the user and/or the legal charge or issue. In another embodiment, the AI engine is operable to engage in text message conversations with a user to identify and/or verify a legal charge type.

In one embodiment, the AI engine is operable to reference at least one database of attorney profiles, wherein the AI engine is operable to identify attorney profiles within a specific jurisdiction or geographic area, wherein the AI engine is further operable to identify attorney profiles based on a specific legal charge or case type. In one embodiment, the AI engine is operable to select at least one attorney profile which matches the jurisdiction and case type of a user.

In one embodiment, if no attorney profiles match the jurisdiction and/or case type, the AI engine is operable to initiate a message to a user, wherein the message indicates no results were found. In one embodiment, if no attorney profiles match the jurisdiction and/or case type, the AI engine is operable to conduct at least one internet search for attorneys not within the attorney profile database. In one embodiment, if no attorney profiles match the jurisdiction and/or case type, the AI engine is operable to engage in text message conversations with a user to identify additional information, wherein the AI engine is further operable to reference the at least one database of attorney profiles based on the additional information.

In another embodiment, the AI engine is operable to engage in text message conversations with a user to schedule a meeting and/or a communication with a matched attorney, wherein the AI engine is operable to reference the calendar and/or schedule of the attorney based on the attorney profile for scheduling the meeting. In one embodiment, the meeting is a phone call. In another embodiment, the meeting is a video call. In another embodiment, the meeting is an in-person meeting. In another embodiment, the AI engine is operable to automatically connect the user with the attorney through text messaging, emailing, or other instant messaging applications. In one embodiment, the AI engine of the server platform is operable to initiate an audio call to a client, wherein the AI engine is operable to verify the information in a client account. In one embodiment, the AI engine is operable to verify the information in a client account by a series of audio prompts to a client during the audio call, wherein the AI engine is operable to receive input responses from a client during the audio call to either confirm or deny the client information.

In an alternative embodiment, the AI engine of the server platform is operable to automatically initiate an email to a client, wherein the AI engine is operable to verify the information in a client account. In one embodiment, the AI engine is operable to verify the information in a client account by a series of written prompts to a client in an email, wherein the AI engine is operable to receive written input responses from a client in a reply email.

In an alternative embodiment, the AI engine of the server platform is operable to automatically initiate a survey and/or questionnaire to a client, wherein the AI engine is operable to verify the information in a client account. In one embodiment, the AI engine is operable to verify the information in a client account by a series of written prompts, multiple choice questions, true or false questions, and/or any other type of question in a survey and/or questionnaire, wherein the AI engine is operable to receive the input responses from a client upon completion and submission of the survey and/or questionnaire.

In one embodiment, the AI engine is operable to automatically generate a summary of a client account and/or a client survey and/or questionnaire. In one embodiment, the AI engine is operable to automatically identify the legal issues of a client based on a client account and/or a client survey and/or questionnaire. In one embodiment, the AI engine is operable to automatically generate suggested next steps for an attorney to take based on a client account and/or a client survey and/or questionnaire. In one embodiment, the AI engine is operable to generate suggested topics for an attorney to discuss with a client based on a client account and/or a client survey and/or questionnaire.

In a preferred embodiment, the platform is operable to utilize at least one AI engine, wherein the at least one AI engine is operable to initiate and engage in communication with at least one user, in real time. In a preferred embodiment, the communication is facilitated through text messages, including short message services (SMS), multimedia messaging services (MMS), or rich communication services (RCS). In another embodiment, the communication is facilitated through email. In another alternative embodiment, the communication is facilitated through an instant messaging application, such as WHATSAPP. In another alternative embodiment, the communication is facilitated through audio calls. In an alternative embodiment, the communication is facilitated through a video call.

In one embodiment, the platform is operable to facilitate communication between at least two users in real time, wherein one user is a client user and a second user is an attorney user. In one embodiment, the communication is facilitated based on the AI engine's recommended matching of a client to an attorney. In a preferred embodiment, the communication is facilitated through text messages, including short message services (SMS), multimedia messaging services (MMS), or rich communication services (RCS). In another embodiment, the communication is facilitated through email. In another alternative embodiment, the communication is facilitated through an instant messaging application, such as WHATSAPP. In another alternative embodiment, the communication is facilitated through audio calls. In an alternative embodiment, the communication is facilitated through a video call. In a preferred embodiment, the communication is facilitated in real-time.

In one embodiment, the server platform is operable to facilitate communication between a plurality of user devices through audio calls and/or video calls. In one embodiment, the audio calls and/or video calls are conducted through a voice over Internet Protocol (VOIP) protocol.

In one embodiment, the server platform receives a request to initiate an audio call and/or a video call from a first user profile, designating at least one other user profile to call. The server platform automatically transmits a notification of the call and an invitation to accept or decline the call in real time to the designated at least one other user profile. In one embodiment, the notification causes at least one user device associated with the at least one other user profile to produce an auditory ring. In one embodiment, the auditory ring is able to be disabled via device settings, profile settings, and/or by muting each of the at least one user devices.

In a preferred embodiment, the AI engine is operable to leave the audio call once the AI engine connects a client and an attorney over the call.

In one embodiment, an audiovisual call interface for a first user profile includes at least one display window. In one embodiment, the at least one display window includes a main video box, showing live camera feed from a camera attached to or associated with at least one user device associated with at least one other user profile, allowing the first user profile to see other participants in the call. In one embodiment, if the at least one user device associated with the at least one other user profile is not associated with or attached to a camera or if the at least one other user profile has disabled video feed, then the main video box is instead filling with a dummy avatar image or a custom image selected by the at least one other user profile. In one embodiment, the at least one display window also includes one or more other video boxes showing live camera feed from cameras attached to or associated with at least one user device associated with user profiles other than the user profile shown in the main video box. In one embodiment, the one or more other video boxes are displayed besides, above, or underneath the main video box. In one embodiment, the at least one display window also includes a self-display box with video feed from a camera attached to or otherwise associated with a user device used by the first user profile. In one embodiment, the self-display box is smaller than the main video box showing camera feed from the at least one other user profile. In one embodiment, the self-display box is layered on top of a section of the main video box. In another embodiment, the self-display box is not layered on top of a section of the main video box, but is instead displayed besides, above, or underneath the main video box.

In one embodiment, the video feed shown in the main video box is able to alternately show video feed from different user devices. In one embodiment, the video feed shown in the main video box is selected based on the user device that is producing the loudest audio feed at any given time. In one embodiment, the video feed shown in the main video box is selected based on the user device producing the most consistent audio over a predetermined amount of time (e.g., 2 seconds, 4 seconds, 10 seconds, etc.). This improves the chances that a main speaker in a conversation is highlighted on the video feed for improved viewing experience. In one embodiment, the server platform caps the number of times the video feed for the main video box is able to changed within a predetermined time interval (e.g., 2 seconds, 5 seconds, 20 seconds, one minute, etc.). In one embodiment, the audiovisual call interface receives a selection (e.g., click selection) to pin one or more video feeds as the main feed, causing the main video box to show only the selected one or more video feeds, regardless of the audio activity levels of each feed, until the one or more video feeds are unpinned.

In one embodiment, the audiovisual call interface includes a gallery view, wherein the display window does not include a main video box, but rather each video box in the gallery view is approximately the same size. In one embodiment, the relative orientation and/or order of each video box is based on the relative audio activity from each corresponding feed. In one embodiment, the audiovisual call interface receives click selection to alternate between the gallery view and the view including the main video box.

In one embodiment, the audiovisual call interface is able to support greater than two individuals simultaneously. For example, in one embodiment, the audiovisual call interface is able to receive, transmit, and display video data for at least 15 participant user profiles simultaneously. In another embodiment, the video and/or audio meetings are able to support at least 30 participants simultaneously. In yet another embodiment, the video and/or audio meetings are able to support at least 50 participants simultaneously. In still another embodiment, the video and/or audio meetings are able to support at least 100 participants simultaneously. One of ordinary skill in the art will understand that alternate numbers of participants are also compatible with the present invention. A participant is defined as a user profile from which the platform receives audio and/or video data from during the course of the video and/or audio calls.

In one embodiment, each user profile is associated with a multiplicity of camera devices on a single video call. In one embodiment, the audiovisual call interface is operable to receive a selection to select one or more of the multiplicity of camera devices and therefore change which camera devices are supplying video feed to the video call in real time. Utilizing multiple camera feeds at once is useful, as it allows focus on more than one user accessing the same computer at the same time, allowing for a more seamless blending of in-person and remote meetings. Alternatively, multiple cameras are able to be used to show multiple parts of the same user simultaneously (e.g., the face and the hands). In one embodiment, the feed from each camera from the same device is displayed in a separate video box in the audiovisual call interface. In one embodiment, a single video box is assigned per device, with one or more of the video boxes split between multiple views (e.g., user 1's video box is vertically, horizontally, or diagonally bisected between a camera feed showing user 1's face and a camera feed showing user 1's hands).

In one embodiment, each user profile is associated with a multiplicity of audio input devices (e.g., microphones) connected to one or more user devices. In one embodiment, the audiovisual call interface is operable to receive a selection to select one or more of the multiplicity of audio input devices and therefore change which audio input devices are supplying audio feed to the video call and/or audio call in real time. In one embodiment, each user profile is associated with a multiplicity of audio output devices (e.g., speakers, headphones, etc.) connected to one or more user devices. In one embodiment, the audiovisual call interface is operable to receive a selection to select one or more of the multiplicities of audio output devices and therefore change which audio output devices are providing audio from the video call and/or audio call to the user device.

In one embodiment, the server platform receives requests from one or more user devices to join a video meeting and/or audio meeting. In one embodiment, if the requests are received before a predetermined start time for a meeting, then a waiting user interface is generated on each user device before the audiovisual call interface is generated at the predetermined start time, automatically adding all user devices previously showing the waiting user interface. In one embodiment, when the server platform receives a request from one or more user devices to join a video meeting and/or audio meeting, the server platform automatically transmits a notification of the attempt and a prompt to accept or deny the one or more user devices to a designated administrator profile for the video meeting and/or audio meeting in real time. If the server platform receives a response to accept a user device joining, then the user device's camera feed and/or audio feed is automatically added to the video meeting and/or audio meeting. If the server platform receives a response to deny a user device joining, then the user device's camera feed and/or audio feed is not added to the video meeting and/or audio meeting.

In one embodiment, the video meeting and/or audio meeting includes a maximum overall capacity (e.g., 2, 4, 10, 50, etc.). In one embodiment, if the maximum number of user devices are already connected to the video meeting and/or audio meeting, and the server platform receives a subsequent request to join the video meeting and/or audio meeting from an additional user device, then a call queue interface is automatically generating on the additional user device. In one embodiment, the call queue interface displays a message that the user is required to wait, a total number of user profiles currently waiting, and/or a number of user profiles in front of the additional user profile. In one embodiment, the queue to join the video meeting works on a first in-first out system. In one embodiment, when the server platform receives a request to join a video meeting and/or audio meeting, the server platform automatically transmits a request to the joining user device to enter at least one password for accessing the video meeting and/or audio meeting, providing for additional privacy. In one embodiment, the password is set by a creator of the video meeting and/or audio meeting.

In one embodiment, the video meeting and/or audio meeting includes a maximum capacity for user profiles of a specific type and/or class. By way of example and not limitation, in one embodiment, the maximum overall capacity is two users, but the video meeting and/or audio meeting is limited to one maximum profile designated as patient and one maximum profile designated as an attorney. This system therefore allows an attorney to continue using the same video chat for multiple scheduled clients without risk of multiple clients joining the same video chat if the attorney accidentally drops from the call.

In one embodiment, the audiovisual call interface accepts user input from a first user device to change video and/or audio settings for a video meeting and/or audio meeting. In one embodiment, video settings include the quality of the transmitted image, designating the maximum quality of image (e.g., 240p, 360p, 480p, 720p, 1080p, 4K, 8K, etc.) transmitted via a camera feed of the first user device, thereby inherently limiting the maximum quality able to be displayed with respect to first user on the screens of other participating user devices. In one embodiment, video settings include a quality of received images, designating the maximum quality of image (e.g., 240p, 360p, 480p, 720p, 1080p, 4K, 8K, etc.) displayed on the first user device with respect to a camera feed from one or more specific other user devices or for the entire video meeting. In one embodiment, video settings include a setting to automatically adjust brightness of the camera feed received by the server platform from the first user device. In one embodiment, when the automatic brightness setting is enabled, the system automatically detects an overall light level and automatically applies a filter, decreasing the light level of the camera feed in order to improve visibility of any individuals appearing in the camera feed.

In one embodiment, the audio settings include a selection between “push-to-talk,” “voice activity,” and “always on.” In a push-to-talk mode, the audiovisual call interface prevents audio from being received from a user device unless the audiovisual call interface receives an input of one or more push keys, enabling audio input from the user device while the one or more push keys are being pressed. In a voice activity mode, in one embodiment, the audiovisual call interface automatically enables audio input from a specific user device when the overall volume of audio received rises above a predetermined threshold. In another embodiment, voice activity mode allows the audiovisual call interface to automatically enable audio input from a specific user device based on the frequency of audio signals received from a specific user device. Other methods of enabling audio based on voice activity that are able to be used in the present application include, but are not limited to, those described in U.S. Patent Publication No. 2018/0240472 and U.S. Pat. Nos. 10,937,448, 8,898,058, 10,229,700, 9,099,098, and 11,138,992, each of which is incorporated herein by reference in its entirety. In an “always on” mode, the audiovisual call interface constantly receives audio input from the user device and constantly transmits audio from the user device to the other participants.

In one embodiment, the audiovisual call interface automatically filters audio signals received from the plurality of participating user devices to better ensure that largely only intended audio data (e.g., voice data) is transmitted to other participating user devices, without background noise that is potentially distracting or irritating. One of ordinary skill in the art will understand that methods for noise filtering for audio signals that are able to be used in the present invention are able to vary and include, but are not limited to, those systems and methods described in U.S. Pat. No. 8,639,516 and/or 8,411,874.

In one embodiment, the server platform receives a selection to disable or modify audio filtering. By way of example and not limitation, in one embodiment, the audiovisual call interface receives a selection to enable a high-fidelity audio mode. In one embodiment, the high-fidelity audio mode decreases or eliminates audio compression performed by the server platform on the audio feed received from a user device. In one embodiment, the high-fidelity audio mode disables echo cancellation performed by the server platform. In one embodiment, the high-fidelity audio mode prevents any audio filtering at all, allowing raw, largely unprocessed audio to be transmitted. While this has a higher chance of transmitting background noise, this setting is also often helpful for playing music. In one embodiment, enabling high-fidelity audio mode is automatically balanced by increasing compression of the video feed, in order to maintain the overall quality of the call and prevent high latency.

In one embodiment, the server platform performs automatic object recognition for the video feed in a video call. The automatic object recognition recognizes and tracks one or more central objects in the video feed (e.g., typically one or more humans). The areas of the video feed not including the central objects are designated as the background of the video feed. In one embodiment, the server platform automatically compresses the background section of the video data. In one embodiment, the server platform automatically blurs the background section of the video data, allowing others to focus on the main object or individual shown in the video feed. In one embodiment, the server platform automatically overlays at least one image and/or video over the background section to further obscure the central object's environment, while providing options for customization. In one embodiment, the server platform receives at least one image and/or video from a user profile to use as the background image. In one embodiment, the system applies one or more temporal filtering techniques in order to smoothly track objects. In one embodiment, the server platform receives a selection to disable the object tracking and/or background blurring, such that the entire frame is more easily visible to other participants. One of ordinary skill in the art will understand that the present invention is able to use any method of object recognition and background filtering known in the art, including, but not limited to, those described in U.S. Pat. Nos. 9,681,125 and 9,633,275, each of which is incorporated herein by reference in its entirety.

In one embodiment, the audiovisual call interface receives a selection to share screen from at least one user device. In one embodiment, when the audiovisual call interface receives a selection to share screen, it automatically transmits a prompt to the selecting user device to choose whether to share a user's entire screen, a portion of the screen, only content from specific applications (e.g., MICROSOFT WORD, GOOGLE CHROME, etc.), only content from specifications windows, and/or only content from specific tabs of an Internet browser. In one embodiment, the audiovisual call interface automatically replaces any video box showing the sharing user profile's video feed with a screenshare feed. In another embodiment, the audiovisual call interface adds an additional video box showing the sharing user profile's screenshare feed in addition to the user profile's video feed. In one embodiment, the screenshare feed mirrors the sharing user's screen. In another embodiment, the screen feed acts as an extension of the sharing user's screen, such that the sharing user device receives an input to, for example, drag and drop windows from their own screen to the screenshare feed.

In one embodiment, each video meeting and/or audio meeting is associated with at least one administrator profile. In one embodiment, the at least one administrator profile is automatically set to be the original creator of the video meeting and/or audio meeting. In one embodiment, a creator of a video meeting and/or audio meeting is able to designate one or more other user profiles as administrator profiles, allowing those profiles to edit permissions for other participants and/or change parameters of the video meeting and/or audio meeting. In one embodiment, the at least one administrator profile is able to set which participant user profiles are able to show video, are able to speak (i.e., from user profiles the server platform is able to receive audio data), and/or which user profiles are able to share a screen of a user device. In one embodiment, the at least one administrator profile is able to limit the number of screenshare feeds that are able to exist in a single video meeting and/or audio meeting at any one time (e.g., limit to only one screenshare per meeting simultaneously). In one embodiment, the server platform receives a request from the at least one administrator user profile to kick or drop one or more participant user profiles from the video meeting and/or audio meeting, causing the server platform to automatically remove the selected one or more participant user profiles from the video meeting and/or audio meeting.

In a preferred embodiment, the AI engine of the server platform is the administrator profile.

In one embodiment, at least one administrator profile of the primary video meeting and/or audio meeting is able to designate at least one sub-administrator profile.

In one embodiment, the audiovisual chat interface is operable to receive text input from at least one user profile. In one embodiment, the audiovisual chat interface displays a running history of chat comments for the video meeting and/or audio meeting, such that users are able to chat, ask questions, or comment on specific issues during the video meeting and/or audio meeting. In one embodiment, the text input includes a designation of at least one other specific user profile to which to send the text. In one embodiment, if the text input is sent to a designated at least one other user profile, then only the at least one other user profile is able to view the text. In another embodiment, if the text input is sent to a designated at least one other user profile, the only the at least one other user profile and at least one administrator profile for the video meeting and/or audio meeting is able to view the text.

In one embodiment, the server platform receives a selection by at least one administrator profile to block any text input during a video meeting and/or audio meeting, allowing the meeting to be more focused, or avoiding potentially inflammatory comments during the meeting. In one embodiment, the server platform receives a selection by at least one administrator profile to block specific other user profiles from providing text input or allowing specific other user profiles to provide text input.

In one embodiment, the text input includes a designation to alert other participants in the video meeting and/or audio meeting or a designation to alert a specific subset of other participant profiles in the video meeting and/or audio meeting. Based on the alert designation, the audiovisual call interface automatically transmits a notification to each designated participant profile (e.g., a push notification, a text notification, an email notification, etc.).

In one embodiment, the audiovisual call interface receives a selection to record the video meeting and/or audio meeting. In response, the server platform automatically saves a copy of the video meeting and/or audio meeting to at least one database. In one embodiment, saved video meetings and/or audio meetings are accessible to at least one administrator profile for the video meeting and/or audio meeting. In one embodiment, the server platform is operable to receive a selection to send a link and/or copy of the recorded video meeting and/or audio meeting to one or more other user profiles, and/or to provide access to the recorded video meeting and/or audio meeting to one or more other user profiles.

In a preferred embodiment, the AI engine is operable to leave the video call once the AI engine connects a client and an attorney over the call.

In one embodiment, the server platform includes a chat interface. Through the chat interface, messages are transmitted directly from one user profile to another user profile, including from a client profile to an attorney profile, or vice versa. In one embodiment, messages transmitted via the chat interface are not publicly visible. However, in one embodiment, messages transmitted via the chat interface are stored in at least one database associated with the server platform. In one embodiment, messages are deleted from the at least one database after a predetermined amount of time (e.g., three days, one week, one month, three months, one year, etc.). In one embodiment, the server platform stores and/or displays metadata regarding each message, including a date and/or time the message was transmitted or received, a location from which the message was transmitted, and/or a type of device from which the message was transmitted (e.g., mobile phone, computer, tablet, etc.). In one embodiment, the chat interface stores and/or displays a date and/or time in which a user first receives a notification that a message was transmitted and/or a date and/or time in which a user first opens the transmitted message. In one embodiment, the server platform receives a selection for a chat message to respond directly to one or more other messages, and the server platform automatically displays a visual indication of the one or more referenced messages with the transmitted chat message.

In one embodiment, the server platform includes a voice-to-text module, which is able to be toggled. As long as the user device includes a microphone, the system is able to automatically convert voice responses to text-based messages. Systems and methods for performing voice-to-text conversion are described in, by way of example and not limitation, U.S. Pat. Nos. 9,547,642, 9,653,076, 9,014,358, and 9,940,923, each of which is incorporated by reference in its entirety. Similarly, in one embodiment, the system includes a text-to-voice reader, which, when enabled, allows a user device to convert text-based messages in a chat history to audio and play the audio. In one embodiment, when the text-to-voice reader is enabled, newly received messages are automatically converted and played via the speakers of the user device. In one embodiment, the user device receives a selection of a previous message in a chat history and automatically plays an audio transcript of all messages transmitted since the selected previous message.

In one embodiment, the server platform receives a selection by a user to edit one or more previous messages and edits the chat log accordingly. In one embodiment, editing messages is only possible for the user profile that originally transmitted those messages. In one embodiment, the server platform stores a date and/or time in which each message was edited in a database. In one embodiment, the server platform saves a record of the pre-edited content of each message and a log of what changes are made in each edit. In one embodiment, the server platform displays a time in which each message was edited in the message history.

In one embodiment, the server platform receives a selection to delete one or more previous messages in a specific chat log and deletes the one or more previous messages accordingly. In one embodiment, deletion of the one or more previous messages also deletes the message from data storage on the one or more databases for the server platform. In another embodiment, deletion does not delete the one or more previous messages from data storage but does remove the one or more previous messages from the chat log. In one embodiment, the one or more previous messages are each replaced with a notification that a previous message was deleted. In another embodiment, the one or more previous messages are simply deleted from the chat log with no notification message.

In one embodiment, the chat interface includes an ability to select a font, a font size, a font color, a bold typeface, an italic typeface, one or more underlines for text, and/or one or more strikethroughs for the text. In one embodiment, the chat interface includes an ability to add one or more automatically formatted bullet points (e.g., circular bullet points, square bullet points, triangular bullet points, etc.), and/or listed points, with points listed by number, roman numeral, and/or letter for one or more messages. In one embodiment, the chat interface includes an ability to add one or more tables to one or more messages. In one embodiment, the chat interface includes an initial selection of a number of rows and/or a number of columns for each of the one or more tables and/or a subsequent selection to add additional rows and/or columns to one or more of the tables.

In one embodiment, when a user profile receives a chat message and/or a reaction from another user profile, the server platform automatically transmits a push notification, a text notification, and/or an email notification to one or more user devices signed into the recipient user profile in real time. In one embodiment, the user profile includes preferences regarding receiving notifications upon receipt of a chat message. By way of example and not limitation, the user profile includes preferences regarding whether notifications are only transmitted when the chat messages are from designated friend profiles, what type of notifications are sent (e.g., push, text, email, etc.), and/or whether notifications are sent at all.

In one embodiment, the server platform is operable to receive a selection of a “reaction” to one or more of the messages. In one embodiment, the reaction includes an emoji (e.g., a thumbs up, a thumbs down, a heart, a face, a flag, etc.). In one embodiment, the chat interface includes an emoji hotbar, providing an ability to transmit one or more predetermined, small graphic images (i.e., emojis) in a message. In one embodiment, the server platform is operable to receive a selection to upload one or more files (e.g., text files, spreadsheet files, image files, audio files, video files, etc.) from the user device to attach to and include with any transmitted messages. In one embodiment, the chat interface includes a native video player for displaying and playing uploaded videos within the chat interface. In one embodiment, the server platform receives a selection to automatically generate at least one video chat and/or audio chat link within the message in order to continue a conversation through other means.

In one embodiment, messages are able to be set to transmit at a later time, after a delay. In one embodiment, messages are set to be transmitted after a predetermined time (e.g., 1 minute, 5 minutes, 15 minutes, 30 minutes, 1 day, 3 days, etc.) after the server receives a selection to transmit the messages. In another embodiment, the server platform receives a specific date and/or time at which to send the selected messages (e.g., on Nov. 1, 2025, etc.). In yet another embodiment, the server platform receives one or more conditions after which the selected messages will be transmitted (e.g., death of the sending user, a specific result in a sport game, political event, and/or other activity, etc.).

In one embodiment, the platform utilizes machine learning to rank client accounts by likelihood to convert to clients on retainer for a specific attorney account.

In one embodiment, the platform is operable to generate an alert when a new client creates an account. In one embodiment, the platform is operable to generate an alert when an existing client inputs a new legal issue. In one embodiment, the alert is an audio alert including a sound from a user device. In one embodiment, the alert is a visual alert including a visual notification on a user device. In one embodiment, the alert is an audiovisual alert, including a sound emitted from a user device and a visual notification on a user device.

In one embodiment, the platform is operable to generate an alert when a new attorney creates an account. In one embodiment, the platform is operable to generate an alert when an existing attorney account updates or changes their legal area of practice.

In one embodiment, the platform is operable to provide financing services, wherein the platform is operable to receive payment from a client and transfer the payment to the client's attorney. In one embodiment, the platform is operable to provide financing plans for clients, wherein the platform is operable to automatically generate a financing plan based on the client's legal issue/case. In one embodiment, the platform is operable to automatically generate a summarization of a financing plan. In one embodiment, the platform is operable to automatically notify an attorney if a client of the attorney has set up a financing plan through the platform. In one embodiment, the platform is operable to request permission from an attorney to generate a financing plan for a client, wherein the platform requires permission of an attorney to generate the financing plan.

In one embodiment, the platform is operable to facilitate a loan to a client who cannot pay the attorney fees, upon consent granted by a client. In one embodiment, the platform is operable to transfer payment to the attorney, without receiving payment from a client.

In one embodiment, the platform is operable to receive a review of an attorney from a client, wherein the platform is further operable to publish the review on the attorney's account/profile. In one embodiment, a review of an attorney must be reviewed and approved by the attorney before the platform publishes the review. In one embodiment, the platform automatically publishes the review once the review is input by a client.

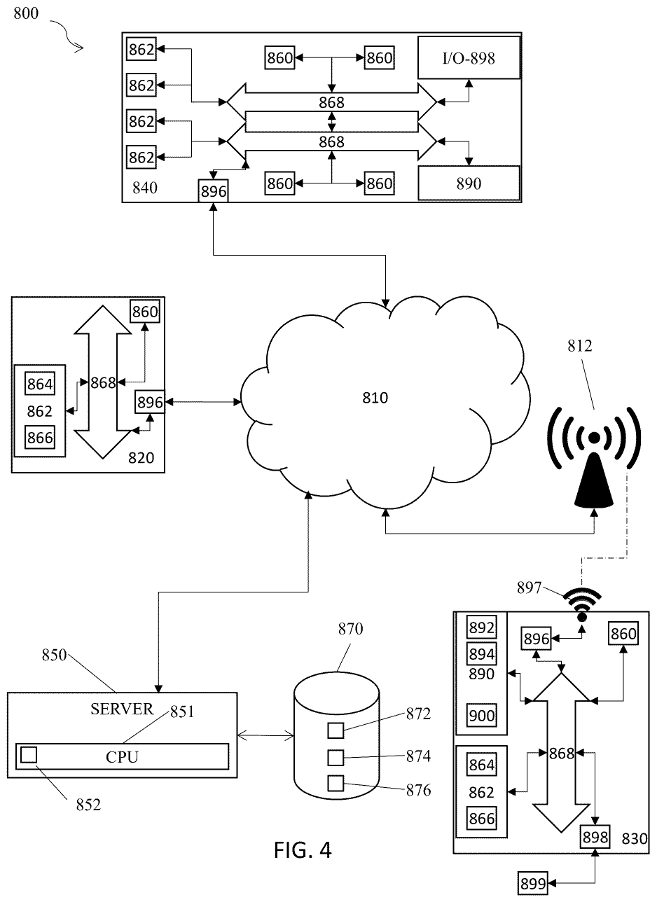

FIG. 4 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 4, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable to be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 4, is operable to include other components that are not explicitly shown in FIG. 4, or is operable to utilize an architecture completely different than that shown in FIG. 4. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A method for automated client and attorney matching, comprising:
providing, via a graphical user interface (GUI), a questionnaire;
receiving, by a computer processor including a memory, an input to the questionnaire;
analyzing, by at least one artificial intelligence (AI) engine, the input to determine a jurisdiction and/or a case type;
referencing, by the AI engine, at least one database, wherein the at least one database includes a plurality of attorney profiles;
selecting, by the AI engine, at least one attorney profile that matches the jurisdiction and/or the case type of the input;
automatically initiating, by the AI engine, a message to a user, wherein the AI engine is operable to send and receive messages in real time;
receiving, by the AI engine, at least one response message;
referencing, by the AI engine, at least one calendar database; and
scheduling, by the AI engine, a meeting between an attorney of the at least one attorney profile and the user.

2. The method of claim 1, wherein the plurality of attorney profiles include attorney information including, a jurisdiction of practice, at least one case type, and an availability schedule.

3. The method of claim 1, wherein the questionnaire includes at least one question, wherein the at least one question relates to a legal case type, a legal charge, a jurisdiction, a date of a charge, a date of a scheduled court appearance, a legal fee range, and/or an availability schedule.

4. The method of claim 1, wherein the message and the at least one response message are text messages.

5. The method of claim 1, further comprising automatically generating a financing plan based on the case type and the at least one attorney profile, wherein the at least one attorney profile includes a fee schedule.

6. The method of claim 1, further comprising automatically generating an alert at the time of the scheduled meeting between an attorney of the at least one attorney profile and the user.

7. The method of claim 1, further comprising verifying, by the AI engine, the jurisdiction and case type based on public records, wherein the public records include public arrest records and/or public court records.

8. The method of claim 1, further comprising verifying an identify of a user.

9. The method of claim 8, further comprising verifying an identify of a user by a series of text message prompts.

10. A system for automated client and attorney matching, comprising:
a server platform with a processor including a memory and the server platform includes at least one artificial intelligence (AI) engine;
wherein the server platform is operable to provide a questionnaire via a graphical user interface (GUI);
wherein the server platform is operable to receive an input to the questionnaire;
wherein the AI engine is operable to analyze the input to determine a jurisdiction and/or a case type;
wherein the AI engine is operable to reference at least one database, wherein the at least one database includes a plurality of attorney profiles;
wherein the AI engine is operable to select at least one attorney profile that matches the jurisdiction and/or the case type of the input;
wherein the AI engine is operable to automatically initiate a message to a user, wherein the AI engine is operable to send and receive messages in real time;
wherein the AI engine is operable to receive at least one response message; and
wherein the AI engine is operable to schedule a meeting between an attorney of the at least one attorney profile and the user.

11. The system of claim 10, wherein the plurality of attorney profiles include attorney information including, a jurisdiction of practice, at least one case type, and an availability schedule.

12. The system of claim 10, wherein the questionnaire includes at least one question, wherein the at least one question relates to a legal case type, a legal charge, a jurisdiction, a date of a charge, a date of a scheduled court appearance, a legal fee range, and/or an availability schedule.

13. The system of claim 10, wherein the message and the at least one response message are text messages.

14. The system of claim 10, wherein the AI engine is operable to automatically generate a financing plan based on the case type and the at least one attorney profile, wherein the at least one attorney profile includes a fee schedule.

15. The system of claim 10, wherein the AI engine is operable to automatically generate an alert at the time of the scheduled meeting between an attorney of the at least one attorney profile and the user.

16. A method for automated client and attorney matching, comprising:
providing, via a graphical user interface (GUI), a questionnaire, wherein the questionnaire includes at least one question, wherein the at least one question relates to a legal case type, a legal charge, a jurisdiction, a date of a charge, a date of a scheduled court appearance, a legal fee range, and/or an availability schedule;
receiving, by a computer processor including a memory, an input to the questionnaire;
analyzing, by at least one artificial intelligence (AI) engine, the input to determine a jurisdiction and/or a case type;
referencing, by the AI engine, at least one database, wherein the at least one database includes a plurality of attorney profiles;
selecting, by the AI engine, at least one attorney profile that matches the jurisdiction and/or the case type of the input;
automatically initiating, by the AI engine, a message to a user, wherein the AI engine is operable to send and receive messages in real time;
receiving, by the AI engine, at least one response message;
referencing, by the AI engine, at least one calendar database; and
scheduling, by the AI engine, a meeting between an attorney of the at least one attorney profile and the user.

17. The method of claim 16, wherein the plurality of attorney profiles include attorney information including, a jurisdiction of practice, at least one case type, and an availability schedule.

18. The method of claim 16, wherein the message and the at least one response message are text messages.

19. The method of claim 16, further comprising automatically generating a financing plan based on the case type and the at least one attorney profile, wherein the at least one attorney profile includes a fee schedule.

20. The method of claim 16, further comprising automatically generating an alert at the time of the scheduled meeting between an attorney of the at least one attorney profile and the user.
